(19) United States
(12) Patent Application Publication
(10) Pub. No.: US 2005/0019216 A1
(43) Pub. Date: Jan. 27, 2005

(54) Apparatus for introducing a sample into a flowthrough analysis system

(76) Inventor: Hans-Heinrich Trutnau, Elsfleth (DE)

Correspondence Address: HOUSTON ELISEEVA, 4 MILITIA DRIVE, SUITE 4, LEXINGTON, MA, 02421, US

(21) Appl. No.: 10/626,231

(22) Filed: Jul. 24, 2003

(51) Int. Cl. G01N 31/00

(52) U.S. Cl. 422/81

(57) ABSTRACT

An apparatus for introducing a sample into a flowthrough analysis system, having a filling point (9) for pressureless filling of a sample loop (11). In addition, a first and a second rotationally actuable six-port valve (3 and 6) are arranged in a conduit system in such a way that after filling of the sample loop (11) via the first valve (3) and by actuation of the first valve (3), a specific working pressure can be generated in the sample loop (11). The second six-port valve (6) is provided in the sample loop (11).

The present invention concerns an apparatus for introducing a sample into a flowthrough analysis system.

In flowthrough analysis systems, e.g. liquid or gas chromatographs or biosensors, samples to be investigated are usually introduced via sample loops. The sample loops are generally filled with the sample to be investigated in pressureless fashion, i.e. while switched out of the flow. During that time, a higher working pressure builds up in the rest of the system, resulting from the corresponding resistance of longer capillaries and the detector cell. A valve switching system for supplying a biosensor with various samples is disclosed in U.S. Pat. No. 5,313,264, which describes a complex system of conduits, valves, and fluid volumes for supplying a biosensor sequentially with different fluids (samples). The second sample for investigation with the biosensor is prepared in the fluid volumes while, concurrently therewith, measurement of the first sample is still taking place at the biosensor. The pressureless fluid volumes are usually switched into the pressurized system for measurement of the second sample. Time passes before a suitable pressure equilibrium has once again become established at the surface of the biosensor. An interference-free measurement is not possible during this time, since the results are greatly dependent on the pressure conditions existing at the surface of the biosensor.

When a pressureless sample loop is switched, by means of a usual alternating switching valve, into the pressurized flow in the manner corresponding to the existing art, the working pressure collapses for a shorter or longer period, since the contents of the sample loop must first be pressurized by compression. This applies not only to gases but also to liquids, which are also compressible. The duration of the pressure drop increases in inverse proportion to the flow rate and in direct proportion to the working pressure of the system, the compressibility of the loop contents, and the volume of the loop relative to the system volume. The effect is expressed, in all pressure- and density-sensitive detector cells (e.g. in refractive-index detectors), as an undesirable and in some cases highly disruptive signal fluctuation.

It is the object of the present invention to create an apparatus with which a switchover to one or more further sample loops is performed in such a way that no signal change occurs as a result of pressure fluctuation during the acquisition of measurement signals.

The object is achieved by way of an apparatus having the features of Claim 1.

The advantages of the invention are based on the fact that the pressure fluctuations that usually occur upon introduction of a sample into the measurement cell of a flowthrough analysis system are ruled out. Since pressure fluctuations influence the measurement accuracy of the measurement cell, prevention of these pressure fluctuations is of critical important for measurement accuracy. The characterizing feature is that the specimen is subjected to the pressure of the rest of the system, by means of a valve, even before its introduction into the measurement cell, so that no pressure fluctuations of any kind occur upon introduction of the sample into the measurement cell by means of a further valve.

The apparatus for introducing a sample into a flowthrough analysis system is configured with a filling point so as thereby to make possible pressureless introduction of the sample. Several valves for controlling the flow of sample, switchable independently of one another, are installed in a conduit system. According to the present invention, a first and a second rotationally actuable six-port valve are provided, arranged in the conduit system in such a way that a specific working pressure can be generated in a sample loop by actuation of the first valve. The second six-port valve is installed in the sample loop (11).

By means of a rotation of the second six-port valve, the working pressure built up in the sample loop can be applied to a detector outlet. The detector outlet is connected to the inlet of a measurement cell of a flowthrough analysis system.

Further advantages and advantageous embodiments are the subject matter of the description below of the Figures, in which, specifically:

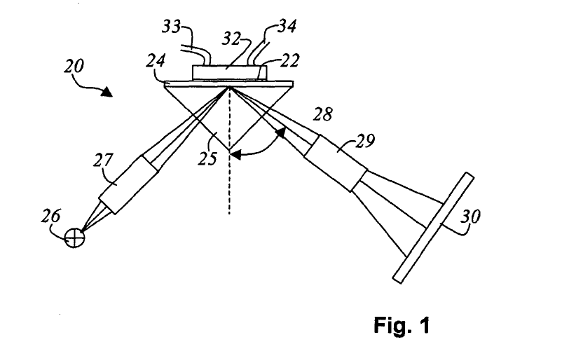

FIG. 1 schematically depicts a flowthrough analysis system operating with SPR technology;

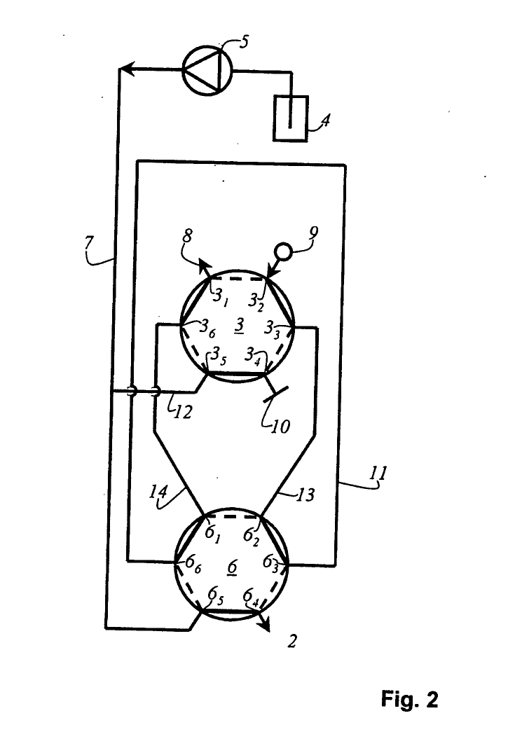

FIG. 2 schematically depicts an apparatus for introducing a sample into a flowthrough analysis system, in which depiction the sample is introduced in pressureless fashion;

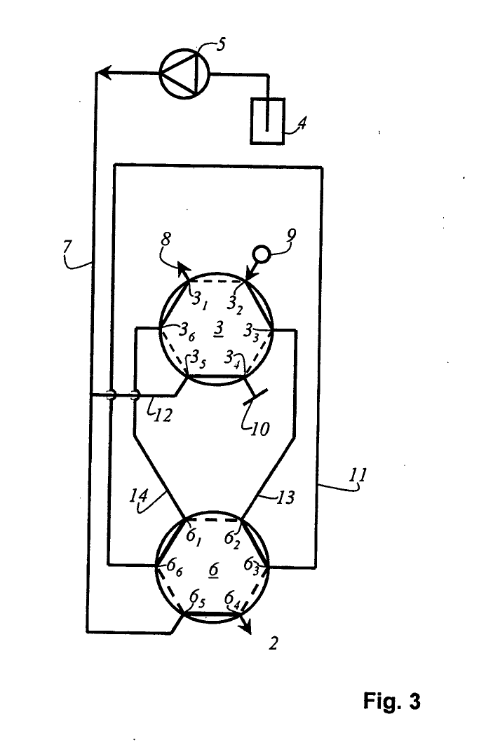

FIG. 3 schematically depicts an apparatus for introducing a sample into a flowthrough analysis system, in which depiction a pressure is applied on the introduced sample; and

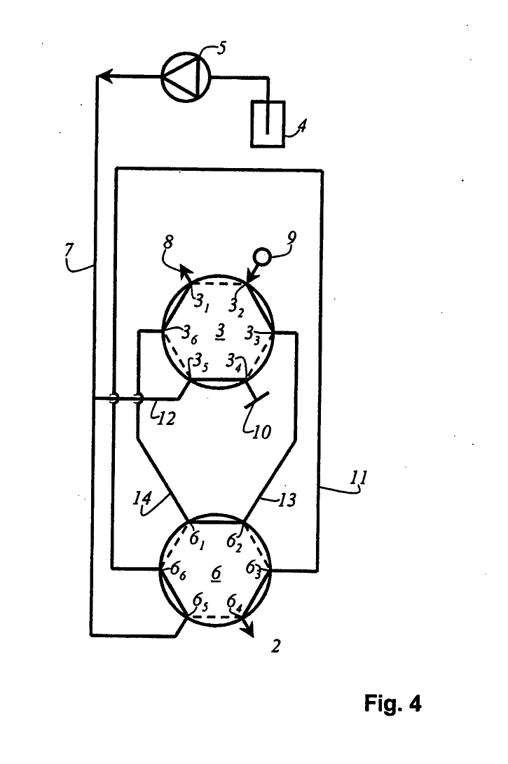

FIG. 4 schematically depicts an apparatus for introducing a sample into a flowthrough analysis system, in which depiction the sample is introduced at a certain pressure into the measurement cell of the flowthrough analysis system.

FIG. 1 schematically depicts a flowthrough analysis system 20 that operates with SPR technology. A sensor surface 22 is applied onto a glass plate 24 coated with a metal layer. Gold is the metal most often used for coating. Glass plate 24 is placed onto a glass prism 25. An oil layer having a suitable refractive index is used for optical coupling between glass plate 24 and glass prism 25. A light bundle 28 from a light source 26 is irradiated by means of a first optical system 27 into glass prism 25, and strikes metal layer 23 of glass plate 24. The gold layer acts as a mirror, reflecting the divergent light bundle 28 toward a linear array 30 of light-sensitive detectors. Provided between glass prism 25 and linear array 30 is a second optical system 29 that shapes the divergent light bundle. A measurement cell 32, embodied here as a flowthrough cell, is provided on sensor surface 22. In the embodiment disclosed here, measurement cell 32 has an inlet 33 and an outlet 34 through which the samples to be investigated can be brought into contact with sensor surface 22 and removed from sensor surface 22. A flowthrough analysis system 20 as described here measures, at sensor surface 22, the sample-related change in refractive index; this also depends, however, on the measurement cell working pressure, which in turn depends on the flow and pressure conditions upstream from measurement cell 32.

FIG. 2 depicts apparatus 1 that can be connected to flowthrough analysis system 20 depicted in FIG. 1. Apparatus 1 possesses a detector outlet 2 that is connected to inlet 33 of measurement cell 32. Also provided is a reservoir 4 of buffer solution that can be delivered as necessary by means of a pump 5. A first and a second commercially available six-port valve 3 and 6 are installed in the conduit system of apparatus 1. Each of the commercially available six-port valves 3 and 6 is equipped with three channels, which can be switched with a 60-degree shift clockwise from a first position (depicted with solid lines) into a second position (depicted with dashed lines), and also shifted back counter-clockwise. The connections among the individual ports 3₁, 3₂, 3₃, 3₄, 3₅, and 3₆ of first valve 3, ports 6₁, 6₂, 6₃, 6₄, 6₅ and 6₆ of second valve 6, and other components of apparatus 1 are implemented by means of capillaries or tubes. The capillaries or tubes represent a conduit system that, in the exemplary embodiment described here, comprise a supply conduit 7, a branch 12, a sample loop 11, and a first and second connecting conduit 13 and 14. The capillaries and tubes are designed as desired depending on the application. On first valve 3, first port 3₁ leads to an overflow 8, second port 3₂ to a filling point 9 for a sample, the third port to second port 6₂ of second valve 6, fourth port 3₄ to a dead end 10, fifth port 3₅ to branch 12, and sixth port 3₆ to first port 6₁ of second valve 6. Branch 12 is in communication with supply conduit 7, which leads from reservoir 4, via fifth and fourth port 6₅ and 6₄ of second valve 6, to detector outlet 2.

Third port 6₃ and sixth port 6₆ of second valve 6 are interconnected via sample loop 11. As already mentioned above, fifth port 6₅ leads to supply conduit 7 and fourth port 6₄ then leads to detector outlet 2.

With first and second valve 3 and 6 in the positions depicted in FIG. 2, pump 5 continuously delivers buffer solution out of reservoir 4 via fifth and fourth port 6₅ and 6₄ of second valve 6 to detector outlet 2. A specific working pressure (backpressure) builds up via measurement cell 32. This working pressure is also present, via fifth and fourth port 3₅ and 3₄ of first valve 3, at dead end 10. Supply conduit 7 is connected to dead end 10 via branch 12 and fifth and fourth port 3₅ and 3₄.

While measurement cell 32 is being loaded with buffer solution via fifth and fourth port 6₅ and 6₄ of second valve 6, sample loop 11 is being filled in pressureless fashion with a sample to be measured. Previously, sample loop 11 and all the other connections between filling point 9 and overflow 8 have usually been filled with buffer solution from the previous analysis run or by means of flushing operations. The filling of sample loop 11 with sample is accomplished via second port 3₂ of first valve 3. The sample moves from second port 3₂ of first valve 3 to third port 3₃, travels from there through first connecting conduit 13 to second port 6₂ of second valve 6, and there enters sample loop 11 through its third port 6₃. Sample loop 11 terminates at sixth port 6₆ of second valve 6. Sixth port 6₆ is connected to first port 6₁ of second valve 6, and second connecting conduit 14 leads from first port 6₁ of second valve 6 to sixth port 3₆ of first valve 3. Through first port 3₁ of first valve 3, the sample finally arrives at overflow 8, so that all the buffer solution has been displaced by the sample into overflow 8. Filling is not, however, necessarily performed all the way to overflow 8, i.e. so that the sample goes to waste. Complete filling with (in this case) liquid medium is [?not] ensured in this case, however, since not-yet-displaced buffer solution is present between the sample front and overflow 8.

FIG. 3 depicts the situation in which sufficient sample has been introduced into sample loop 11 of apparatus 1, and first valve 3 has been shifted 60 degrees clockwise. The result of this is that backpressure builds up in sample loop 11 as well. The buildup of backpressure is accomplished from supply conduit 7 through branch 12 and fifth and sixth port 3₅ and 3₆ of first valve 3. By means of second connecting conduit 14, the pressure travels to first port 6₁ of second valve 6, and from there to sixth port 6₆ of second valve 6. The backpressure is built up via sample loop 11 to third and second port 6₃ and 6₂ of second valve 6. From second port 6₂ of second valve 6, the backpressure is built up via first connecting conduit 13 to third and fourth port 3₃ and 3₄ of first valve 3. The desired pressure level is achieved by the fact that fourth port 3₄ of first valve 3 ends at dead end 10. Because of the compression of the volume in sample loop 11, the pressure in the rest of the apparatus now briefly collapses. This means that a pressure drop also occurs in measurement cell 32, so that at that point in time usually no signal recording is performed. This is less important since no relevant measurement results are expected from the buffer solution at this time. A measurement at an unstable pressure would cause the readings to be influenced by the pressure fluctuations. Once the working pressure has been re-established (and prior to the sample addition described in FIG. 4), signal recording can be started for interference-free acquisition of a so-called baseline. In the meantime, if necessary, the connection at first valve 3 between filling point 9, via second port 3₂ and first port 3₁, and overflow 8 is purged with a suitable solution.

FIG. 4 depicts the situation in which second valve 6 is now shifted clockwise in such a way that the backpressure built up in sample loop 11 can now also act, without fluctuations, in measurement cell 32. Because second valve 6 has been shifted, sample loop 11 is now connected from supply conduit 7, via fifth and sixth port 6₅ and 6₆ of second valve 6, and via third and fourth port 6₃ and 6₄ of second valve 6, directly to detector outlet 2. Since it was possible, even before delivery of the sample onto sensor surface 22 of measurement cell 32, to build up in sample loop 11 a working pressure corresponding to the backpressure of the apparatus, no pressure-related signal fluctuations of any kind occur. The sample-related signal can be recorded in the measurement cell without interference. It is no longer necessary to wait a certain amount of time prior to signal recording until a pressure equilibrium has been established in measurement cell 32 after sample delivery, especially since in such a case the particularly significant initial signal would be lost because it was not recorded.

The invention has been described with reference to preferred embodiments. Changes and modifications to the method or the system can be made without thereby leaving the range of protection of the claims below.

1. An apparatus for introducing a sample into a flowthrough analysis system, having a filling point (9) for pressureless filling of a sample loop (11), and a conduit system in which a valve circuit for sample delivery is installed,
wherein a first and a second rotationally actuable six-port valve (3 and 6) are arranged in the conduit system in such a way that after filling of the sample loop (11) via the first valve (3), a specific working pressure can be generated in the sample loop (11) by actuation of the first valve (3), the second six-port valve (6) being installed in the sample loop (11).

2. The apparatus as defined in claim 1, wherein with the second six-port valve (6), the working pressure built up in the sample loop (11) can be applied by means of a rotation onto a detector outlet (2).

3. The apparatus as defined in claim 1, wherein the first and second rotationally actuable six-port valve (3 and 6) are rotationally actuable clockwise and counter-clockwise.

4. The apparatus as defined in claim 2, wherein the detector outlet (2) leads to an inlet (33) to a measurement cell (32).

5. The apparatus as defined in claim 4, wherein the measurement cell (32) is a component of a flowthrough analysis system; and the flowthrough analysis system is a liquid chromatograph or a gas chromatograph or a biosensor.

6. The apparatus as defined in claim 1, wherein the first six-port valve (3) has a first port (3₁) that leads to an overflow (8), has a second port (3₂) that leads to a filling point (9) for a sample, has a third port (3₃) that leads to a first connecting conduit (13), has a fourth port (3₄) that leads to a dead end (10), has a fifth port (3₅) that leads to a branch (12), and has a sixth port (3₆) that leads to a second connecting conduit (14).

7. The apparatus as defined in claim 1, wherein the second six-port valve (6) has a first port (6₁) at which the second connecting conduit (14) ends, has a second port (6₂) at which the first connecting conduit (13) ends, has a third port (6₃) that is connected to the sample loop (11), has a fourth port (6₄) that leads to a detector outlet (2), has a fifth port (6₅) at which a supply conduit (7) ends, and has a sixth port (6₆) that is also connected to the sample loop (11).
